(19) United States
(12) Patent Application Publication
(10) Pub. No.: US 2007/0091730 A1
(43) Pub. Date: Apr. 26, 2007

(54) Watchstrap

(76) Inventor: Shao-Chieh Ting, Banchiau City (TW)

Correspondence Address: TROXELL LAW OFFICE PLLC;SUITE 1404, 5205 LEESBURG PIKE, FALLS CHURCH, VA, 22041, US

(21) Appl. No.: 11/254,657

(22) Filed: Oct. 21, 2005

(51) Int. Cl. G04B 37/00

(52) U.S. Cl. 368/282

(57) ABSTRACT

A watchstrap according to the invention includes a plug for signal transmission connecting with a body of a watch by a transmission line to achieve data storage and access between the body and an access device. A groove to accommodate the plug is configured on the watchstrap, and an inlaying groove extends from the recess to the body with characteristics that the thickness of the watchstrap equals to that of the plug to enable the both sides of the plug to level with the obverse and reverse sides of the watchstrap when the plug is accommodated in the recess, a flat inlaying groove and a flat transmission line level with the watchstrap when being assembled.

### BACKGROUND OF THE INVENTION

(a) Field of the Invention

The present invention relates to a watchstrap connecting with a plug, and more particularly to a watchstrap connecting a plug for signal transmission characterized in that when the plug is devised in the watchstrap, obverse and reverse sides of the watchstrap remain even.

(b) Description of the Prior Art

As the technology advances, portable disks have become more and more popular. Other than data storage and access, portable disks have integrated with MP3 players, recording pens, radios, digital cameras and other technologies; moreover, the capacity have increased from 8M and 16M of early stages to as large as 256M, 512M and even to 1 G nowadays.

The portable disks with large capacities for data storage are compact and convenient while providing the most efficient assistance for data management.

However, a hole to be assembled with suspenders is added on a housing of a portable disk for conveniences when being worn or suspended on backpacks or briefcases.

Another kind of portable disks is assembled on watches to enhance conveniences in carrying. Referring to FIG. 1, a watch comprises a body 10, and a strap 11 on each side thereof respectively and correspondingly. The body 10 is consisted of a transmission line A comprising a round connecting wire B and a USB connector C on one end thereof. A containing space is configured on the strap 11 correspondingly with the position of the transmission line A to fit the transmission line A therein. A protruding section D corresponding with the containing space on the reverse side of the watchstrap is formed to assemble the watch with the transmission line A.

The protruding section D corresponding with the containing space on the reverse side of the strap causes disturbances and discomfort when being worn, and even decreases sales in the market as a result. Therefore, it is a vital task of the invention to provide an assembly of a watch and a portable disk avoiding discomfort when being worn.

### SUMMARY OF THE INVENTION

The primary object of the invention is to provide a watchstrap comprising a data-transmitting plug, which connects to a body of the watch by a transmission line to provide data storage and access function between the body and an access device; a containing space configured on the watchstrap to accommodate the plug, an inlaying groove extended from the recess to the body and with characteristics in that the thickness of the watchstraps equals to that of the plug for the obverse and reverse side of the watchstrap to be leveled with both sides of the plug when the plug is stored in the recess; the inlaying groove on the watchstrap and the transmission line are flat such that when the transmission line is inlaid, it is leveled with a surface of the watchstrap. With the recess and inlaying groove, when the plug and the flat transmission line are accommodated therein respectively, the obverse and reverse sides of the watchstrap remain even.

To better understand the invention, detailed descriptions of a preferred embodiment shall be given with the accompanying drawings below.

### BRIEF DESCRIPTION OF THE DRAWINGS

FIG. 1 shows an elevational view according to the prior art.

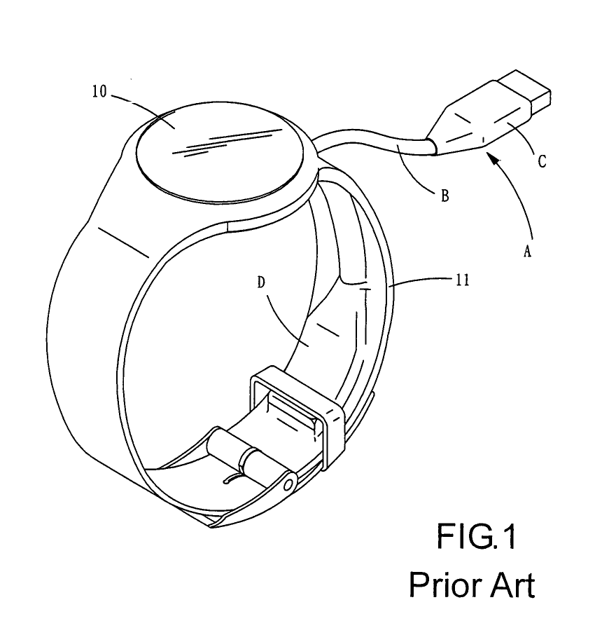

FIG. 2 shows an elevational view according to the invention.

FIG. 3 shows a schematic view according to the invention.

FIG. 3A shows an enlarged partial sectional view of FIG. 3.

FIG. 4 shows a sectional view of an assembled watchstrap with a plug according to the invention.

FIG. 5 shows a schematic view illustrating motions according to the invention.

### DETAILED DESCRIPTION OF THE PREFERRED EMBODIMENTS

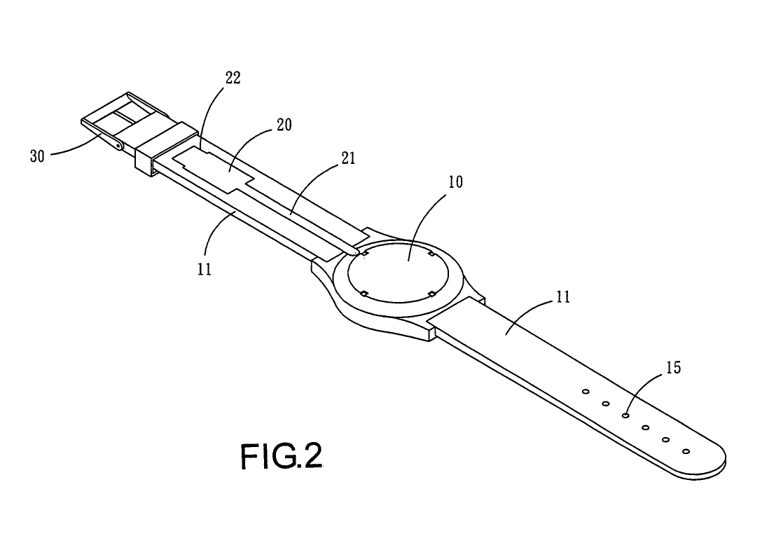

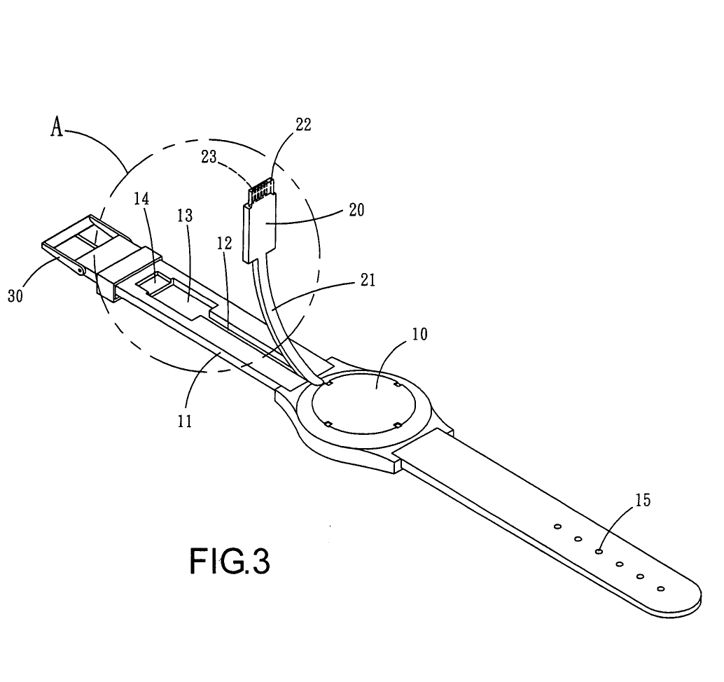

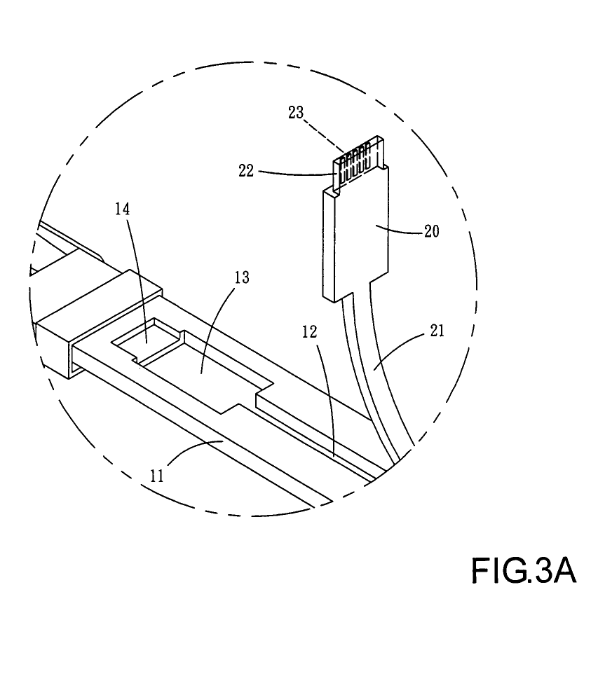

Referring to FIG. 2 and FIG. 3, a watch comprises a time and date displaying body with the features of an alarm and a stopwatch, and watchstraps 11 configured correspondingly on two sides of the body. At least one memory module for data storage is embedded within the body 10, and a plug 20 is connected externally thereon. A flat inlaying groove 12 extending outward from the body 10 is configured externally on one of the watchstraps and joins with a recess 13, which penetrates through the obverse and reverse sides of the watchstrap 11. A containing space 14, which does not penetrate through the watchstrap, is configured correspondingly with the inlaying groove 12 on the other side of the recess 13.

The plug 20 connects to the body 10 of the watch by the transmission line 21 to achieve circuit connection between the body 10 and a data access device, such as a card reader or a computer with USB, and data storage and access of the embedded memory module of the body 10. Referring to FIG. 3A, the thickness of the plug 20 equals to that of the watchstrap 11. Wherein, a plurality of terminals 23 is devised in a protruding connector 22 at the tip of the plug 20 in the position corresponding with the lower configuration of the containing space 14. Furthermore, the transmission line 21 and the inlaying groove 12 are flat.

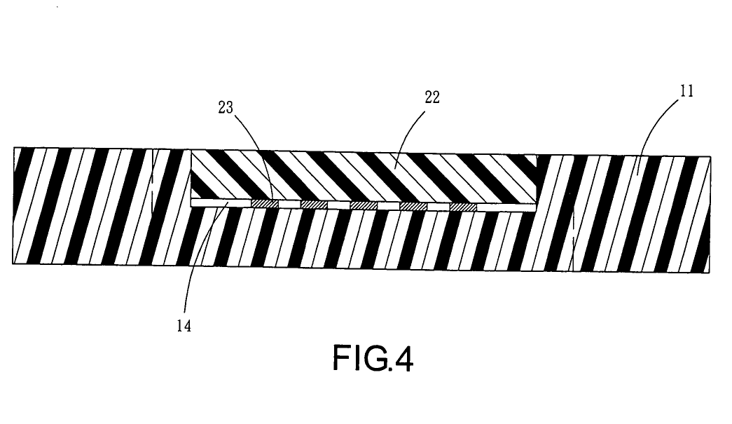

As shown in FIG. 4, when a plug 20 is placed in a recess 13, the upper and lower sides thereof level with the obverse and reverse sides of the watchstrap because the thickness of the plug 20 equals to that of the watchstrap 11. Moreover, a connector 22 at the tip of the plug 20 is placed in a containing space 14 to allow terminals 23 of the connector 22 to be adjacent to a lower section of the containing space 14 and to avoid damages. Meanwhile, the flat transmission line 21 is inlaid in the inlaying groove 12, and levels with the reverse side of the watchstrap 11 avoiding discomfort when being worn.

Furthermore, for size adjustment according to the user's wrist, a buckling device 30 is installed on one side of the watchstrap 11 while a plurality of holes 15 is configured on the other side thereof for the buckling device 30 to buckle into any of the holes 15.

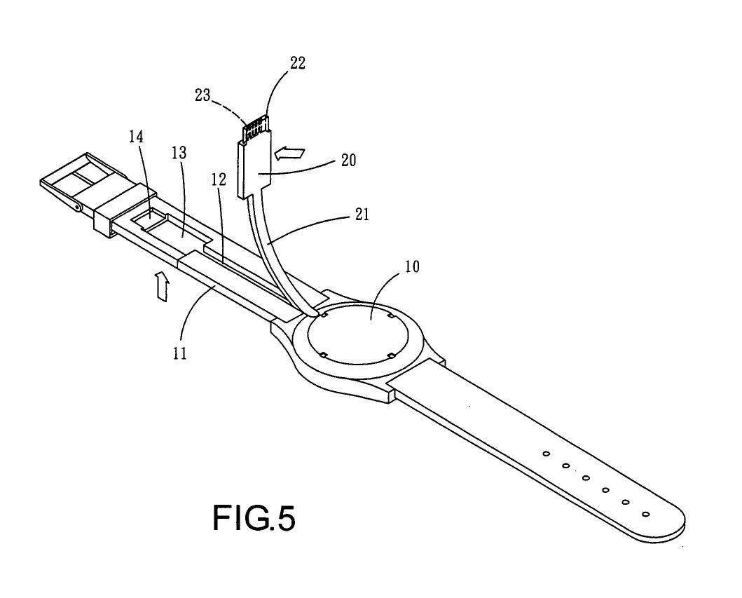

According to FIG. 5, during operation, a plug 20 is pushed from the obverse to the reverse side of a watchstrap 11 to depart from a recess 13 thereon, expose terminals 23 on a connector 22 and cause a transmission line 21 to depart from an inlaying groove 12, thereby enabling the connector 22 at the tip of the plug 20 to connect and achieve circuit connection with the access device via the terminals 23. Thus, an embedded memory module in the body 10 becomes capable of storing and accessing data with the access device.

After usage, the plug 20 and the transmission line 21 are leveled and attached to obverse and reverse sides of the watchstrap 11 to offer the terminals 23 with protection by pressing the plug 20 from the reverse side toward the obverse side of the watchstrap 11 to accommodate the plug 20 in the recess 13, the connector 22 at the tip of the plug 20 in the containing space 14, and the transmission line 21 in the inlaying groove 12. Furthermore, damages caused by sweat or dust can be avoided by adding a protection cover (not shown in the figures) to the terminals 23.

In addition, features of the invention are extended when the body 10 connects to a digital camera, an MP3 player, a recording pen, a radio or the other devices.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A watchstrap of a watch comprising a time-displaying body with at least one embedded memory module for data storage and access, the watchstraps in two corresponding sides of the body, a plug connected by a transmission line devised outside of the body; and characteristics that:
the thickness of the watchstraps equals to that of the plug; an inlaying groove is extended from one side of a recess for plug accommodation to the body on the watchstrap to accommodate the transmission line; a containing space is configured on the other side of the recess, and terminals of a connector configured on the plug is devised correspondingly with the position of the containing space such that when the plug is accommodated in the recess, the obverse and reverse sides of the watchstrap remain even with both sides of the plug; the inlaying groove and the transmission line are flat such that when the transmission line is inlaid, it is leveled with a surface of the watchstrap.

2. The watchstrap in accordance with claim 1, wherein the body provides features of a digital camera, MP3 player, recording pen, radio, and . . . etc.

3. The watchstrap in accordance with claim 1, wherein the plug is an Universal Serial Bus (USB).

4. The watchstrap in accordance with claim 1, wherein a protecting cover is devised on the plug.

5. The watchstrap in accordance with claim 1, wherein the recess penetrates through obverse and reverse sides of the watchstrap.

6. The watchstrap in accordance with claim 1, wherein the containing space does not penetrate through the watchstrap.
